(19) United States
(12) Patent Application Publication
(10) Pub. No.: US 2024/0112852 A1
(43) Pub. Date: Apr. 4, 2024

(54) FIELD SUPPRESSION FEATURE FOR GALVANIC ISOLATION DEVICE

(71) Applicant: Texas Instruments Incorporated, Dallas, TX (US)

(72) Inventors: Jeffrey Alan West, Dallas, TX (US); Byron Lovell Williams, Plano, TX (US); Kashyap Barot, Bangalore (IN); Sreeram N. S., Bangalore (IN); Viresh Chinchansure, Bangalore (IN)

(21) Appl. No.: 17/957,875

(22) Filed: Sep. 30, 2022

(51) Int. Cl. H01F 27/32; H01F 41/12

(52) U.S. Cl. CPC H01F 27/324; H01F 41/122; H01F 2027/329

(57) ABSTRACT

A microelectronic device includes a galvanic isolation component. The galvanic isolation component includes a lower winding and an upper isolation element over the lower winding. The galvanic isolation component further includes a field suppression structure located interior to the lower winding. The field suppression structure includes a conductive field deflector that is separated from the lower winding by a lateral distance that is half a thickness of the lower winding to twice the thickness of the lower winding. A top surface of the conductive field deflector is substantially coplanar with a bottom surface of the lower winding. The conductive field deflector is electrically connected to a semiconductor material in a substrate. The lower winding is separated from a substrate by a first dielectric layer. The upper isolation element is separated from the lower winding by a second dielectric layer.

### TECHNICAL FIELD

This disclosure relates to the field of microelectronic devices. More particularly, but not exclusively, this disclosure relates to galvanic isolation devices.

### BACKGROUND

Galvanic isolation devices are used to transfer signals and power between two circuits operating at different potentials. The difference in the potentials may be over 600 volts, which produces high electric fields in dielectric material of the galvanic isolation devices.

### SUMMARY

The present disclosure introduces a microelectronic device having a substrate with a semiconductor material. The microelectronic device includes a galvanic isolation component over the substrate. The galvanic isolation component includes a lower winding, separated from the substrate by a first dielectric layer, and an upper isolation element over the lower winding. The upper isolation element is separated from the lower winding by a second dielectric layer. The galvanic isolation component further includes a field suppression structure located interior to the lower winding, so that the lower winding extends around the field suppression structure. The field suppression structure includes a conductive field deflector that is separated from the lower winding by a lateral distance from half a thickness of the lower winding to twice the thickness of the lower winding. A top surface of the conductive field deflector is substantially coplanar with a bottom surface of the lower winding. The conductive field deflector is electrically connected to the semiconductor material. A method of forming the microelectronic device is disclosed.

### BRIEF DESCRIPTION OF THE VIEWS OF THE DRAWINGS

FIG. 1A and FIG. 1B are a perspective and a cross section, respectively, of an example microelectronic device having a galvanic isolation component with a field suppression structure.

FIG. 2A through FIG. 2F are cross sections of a microelectronic device having a galvanic isolation component with a field suppression structure, depicted in successive stages of an example method of formation.

FIG. 3A and FIG. 3B are a perspective and a cross section, respectively, of another example microelectronic device having a galvanic isolation component with a field suppression structure.

FIG. 4A through FIG. 4F are cross sections of a microelectronic device having a galvanic isolation component with a field suppression structure, depicted in successive stages of an example method of formation.

FIG. 5 is a cross section of a further example microelectronic device having a galvanic isolation component with a field suppression structure.

### DETAILED DESCRIPTION

The present disclosure is described with reference to the attached figures. The figures are not drawn to scale and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

The following co-pending patent applications have related subject matter and are hereby incorporated by reference: U.S. patent application Ser. No. 17/957,847 (Texas Instruments docket number T102472US01, titled “GALVANIC ISOLATION DEVICE”, by West, et al.), and U.S. patent application Ser. No. xx/xxx,xxx (Texas Instruments docket number T92886US01, titled “SINGLE DIE REINFORCED GALVANIC ISOLATION DEVICE”, by West, et al.), both filed simultaneously with this application. With their mention in this section, these patent applications are not admitted to be prior art with respect to the present invention.

For the purposes of this disclosure, a structure or component that is disclosed as including “primarily” a substance has more than 50 percent, by weight, of that substance. For example, an interconnect that is disclosed to include primarily aluminum has more than 50 percent, by weight, of the element aluminum. Similarly, an interconnect that is disclosed to include primarily copper has more than 50 percent, by weight, of the element copper.

For the purposes of this disclosure, the term “silicon dioxide” includes dielectric material which is primarily silicon dioxide with a few percent of hydrogen, water, hydroxyl groups, boron, fluorine, or other material, by weight. The term silicon dioxide includes dielectric material formed by a plasma enhanced chemical vapor deposition (PECVD) process using tetraethyl orthosilicate (TEOS), formally named tetraethoxysilane, and oxygen. The term silicon dioxide also includes dielectric material formed by a high density plasma (HDP) process using silane and oxygen.

For the purposes of this disclosure, the term “substantially coplanar” refers to surfaces that are coplanar within fabrication effects encountered during etching and polishing layers of of the microelectronic device. For example, a top surface of a first conductive element formed in a dielectric layer is substantially coplanar with a bottom surface of second conductive element formed on the dielectric layer, notwithstanding the fact that the top surface of the first conductive element may extend slightly, that is, less than 50 nanometers, above or below a plane of the bottom surface of the second conductive element.

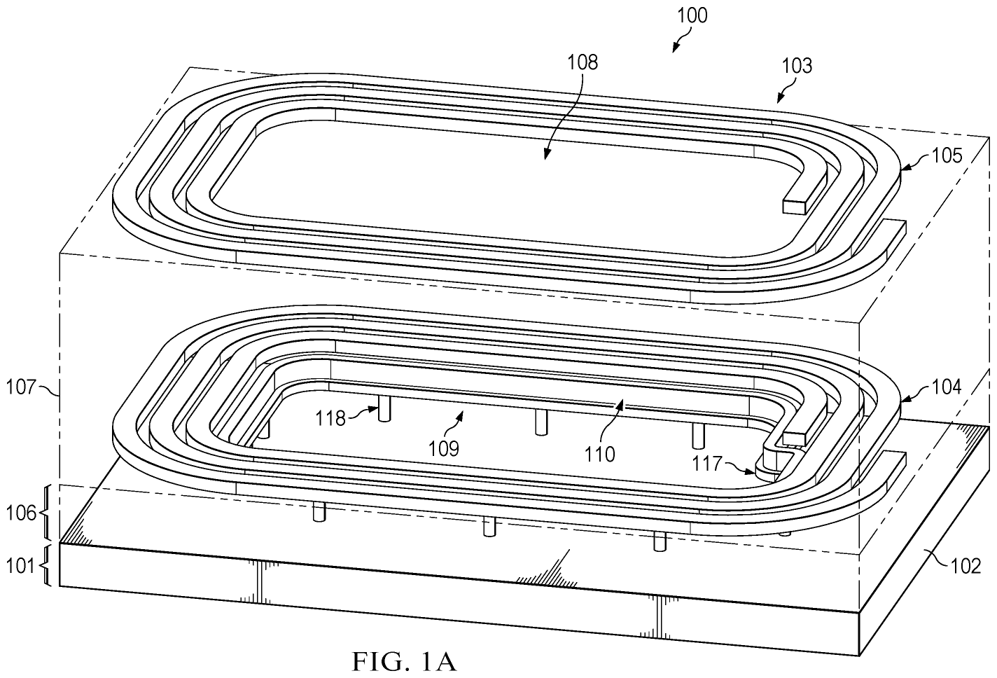

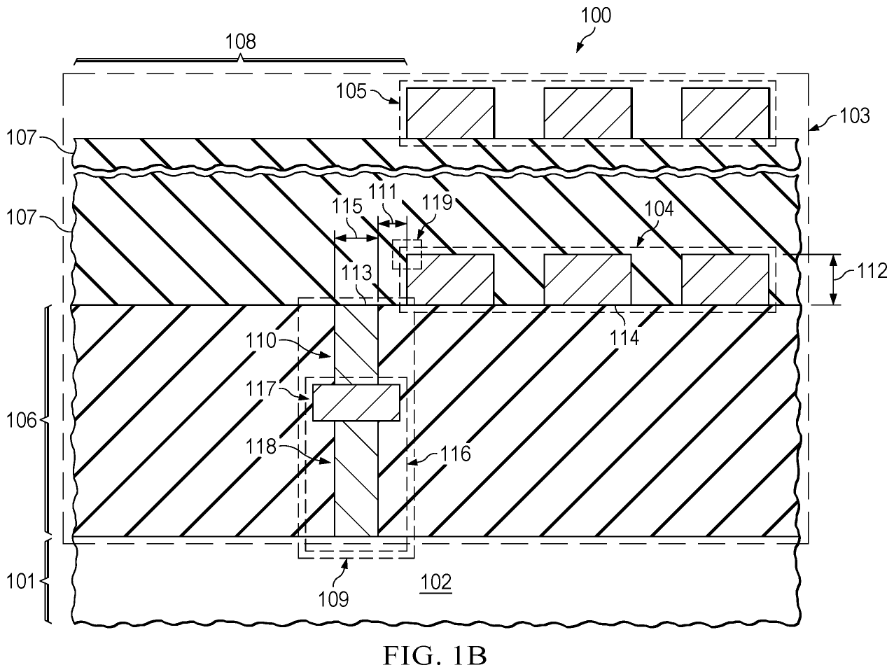

FIG. 1A and FIG. 1B are a perspective and a cross-section, respectively, of an example microelectronic device having a galvanic isolation component with a field suppression structure. The microelectronic device 100 may be manifested as a standalone isolation device, or may be manifested as multi-chip module that includes a galvanic isolation device, an integrated circuit, a microelectrical mechanical system (MEMS) device, a microfluidic device, or an electro-optical device, by way of example. The microelectronic device 100 includes a substrate 101 having a semiconductor material 102. The substrate 101 may be manifested as a portion of a bulk silicon wafer, a bulk silicon wafer with an epitaxial silicon layer, or a silicon-on-insulator (SOI) wafer, by way of example. The semiconductor material 102 may be monocrystalline silicon, with n-type dopants or p-type dopants. Alternatively, the semiconductor material 102 may include a III-V semiconductor material such as gallium nitride or gallium arsenide, or another semiconductor material such as silicon carbide.

The microelectronic device 100 includes a galvanic isolation component 103 over the substrate 101. The galvanic isolation component 103 includes a lower winding 104 and an upper isolation element 105 over the lower winding 104. The upper isolation element 105 may be manifested as an upper winding, as indicated in FIG. 1A and FIG. 1B, or a magnetic sensor, for example.

The microelectronic device 100 includes a first dielectric layer 106 over the substrate 101. The lower winding 104 is separated from the substrate 101 by the first dielectric layer 106. The first dielectric layer 106 may include a plurality of sublayers, not specifically shown, such as a sublayer of thermal oxide, a plurality of sublayers of silicon nitride, a plurality of sublayers of silicon dioxide. Other sublayer structures and compositions for the first dielectric layer 106 are within the scope of this example. The first dielectric layer 106 may be 600 nanometers to 10 microns thick, by way of example. The microelectronic device 100 includes a second dielectric layer 107 over the lower winding 104 and the first dielectric layer 106. The upper isolation element 105 is separated from the lower winding 104 by the second dielectric layer 107. The second dielectric layer 107 may include a plurality of sublayers, not specifically shown, such as sublayers of low stress silicon dioxide, sublayers of high stress silicon dioxide, and one or more sublayers of silicon nitride or silicon oxynitride, for example. Other sublayer structures and compositions for the second dielectric layer 107 are within the scope of this example. The second dielectric layer 107 is sufficiently thick to provide reliable operation of the microelectronic device 100 when a potential difference of at least 600 volts is applied between the upper isolation element 105 and the lower winding 104. By way of example, a thickness of 19 microns to 22 microns for the second dielectric layer 107 may provide reliable operation at 1000 volts, and may withstand surge potentials of 10,000 volts.

The lower winding 104 surrounds an interior region 108 of the first dielectric layer 106. The microelectronic device 100 includes a field suppression structure 109 in the interior region 108. The field suppression structure 109 is located interior to the lower winding 104. The field suppression structure 109 includes a conductive field deflector 110 that is separated from the lower winding 104 by a lateral distance 111 that is half a thickness 112 of the lower winding 104 to twice the thickness 112 of the lower winding 104. A top surface 113 of the conductive field deflector 110 is substantially coplanar with a bottom surface 114 of the lower winding 104. The conductive field deflector 110 is electrically connected to the semiconductor material 102. A top width 115 of the top surface 113 may be greater than half of the thickness 112 of the lower winding 104. In one version of this example, the conductive field deflector 110 of this example may extend completely around the interior region 108, as depicted in FIG. 1A. In another version of this example, the conductive field deflector 110 of this example may have separate segments, with the segments arranged around the interior region 108. In a further version, in which a lower conductor, not specifically shown, extends from the interior region 108 under a portion of the lower winding 104, the conductive field deflector 110 may be interrupted at edges of the lower conductor, and a segment of the conductive field deflector 110 may be located on the lower conductor.

In this example, the conductive field deflector 110 may be electrically connected to the semiconductor material 102 through a shunt 116 that extends from the conductive field deflector 110 through the first dielectric layer 106 to the semiconductor material 102. The shunt 116 of this example may include a shunt interconnect line 117 under the conductive field deflector 110 and one or more shunt contacts 118 on the semiconductor material 102, extending between the shunt interconnect line 117 and the semiconductor material 102. The first dielectric layer 106 and the second dielectric layer 107 are not shown in FIG. 1A, to show the lower winding 104 and the field suppression structure 109 more clearly.

During operation of the microelectronic device 100, a potential difference of at least 600 volts is applied between the upper isolation element 105 and the lower winding 104, which produces a high electric field at an upper interior corner 119 of the lower winding 104. The conductive field deflector 110 may advantageously reduce the electric field at the upper interior corner 119 by providing a conductive surface close to the upper interior corner 119 at a potential within a few volts of an average potential of the lower winding 104. The shunt 116 maintains the potential of the conductive field deflector 110 at the potential of the semiconductor material 102. Work performed during development of the field suppression structure 109 has shown that having the lateral distance 111 between the conductive field deflector 110 and the lower winding 104 to be between half the thickness 112 of the lower winding 104 and twice the thickness 112 of the lower winding 104 reduces the electric field at the upper interior corner 119 by at least 20 percent. Having the top width 115 of the top surface 113 greater than half of the thickness 112 of the lower winding 104 may advantageously further reduce the electric field at the upper interior corner 119.

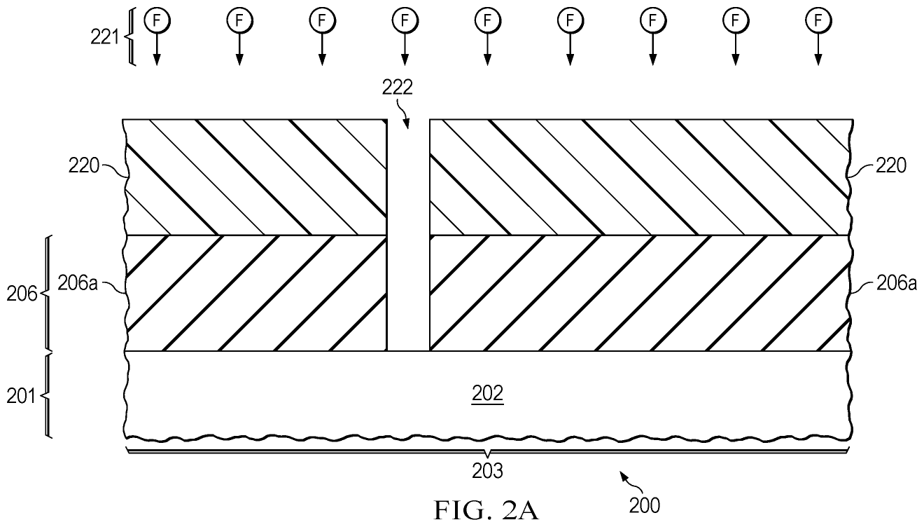

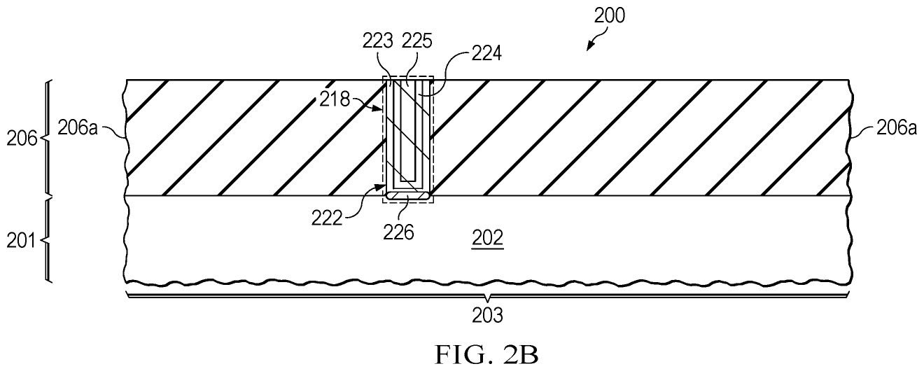

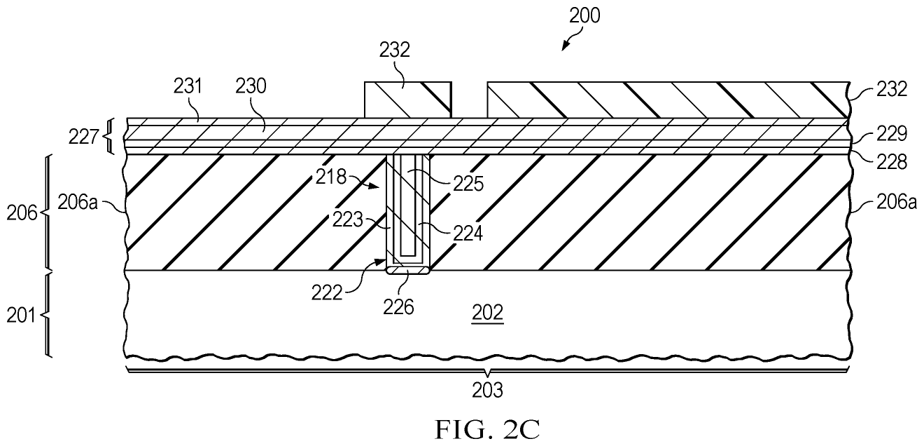

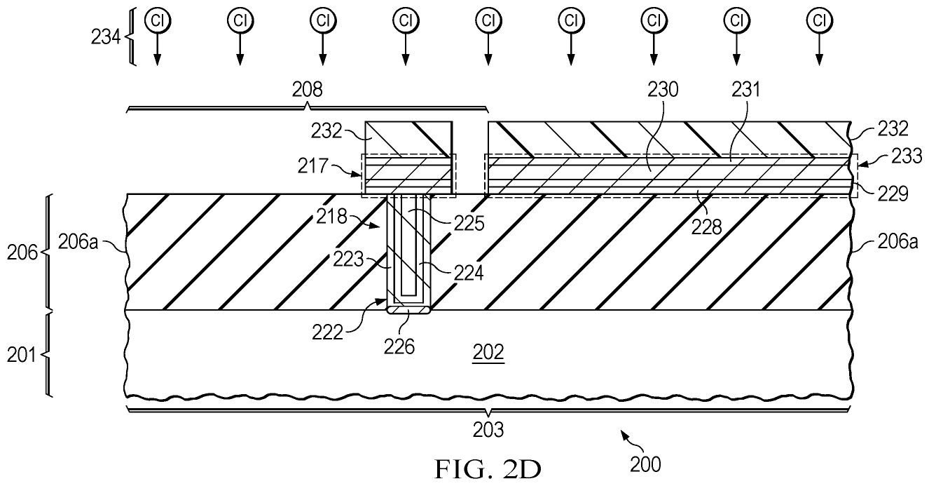

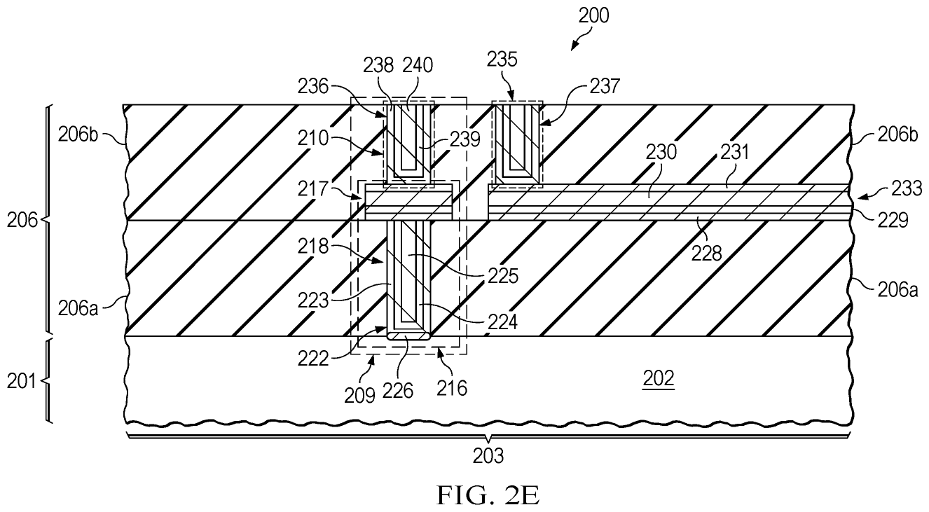

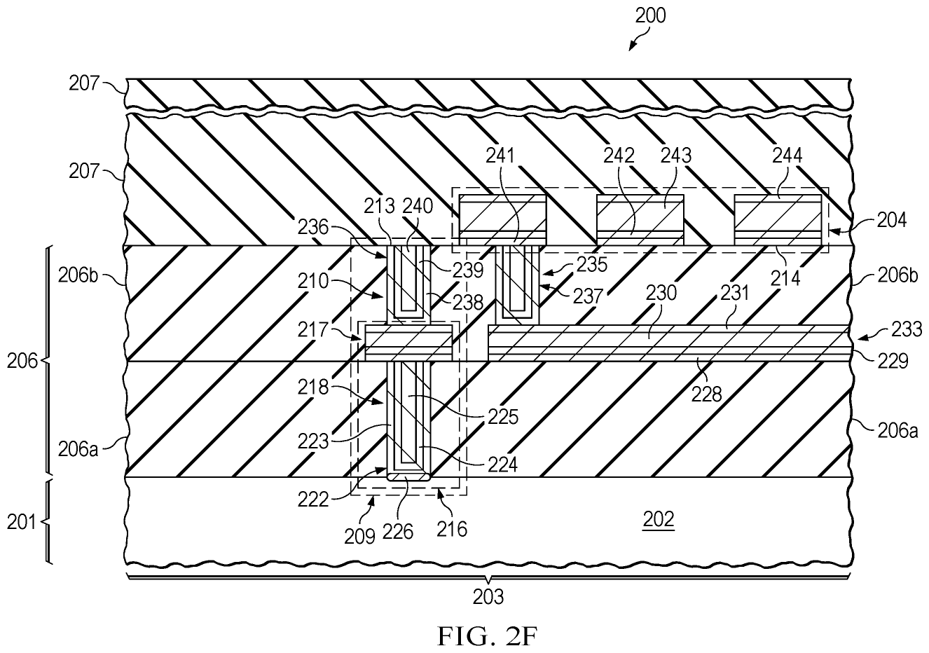

FIG. 2A through FIG. 2F are cross sections of a microelectronic device having a galvanic isolation component with a field suppression structure, depicted in successive stages of an example method of formation. Referring to FIG. 2A, the microelectronic device 200 is formed on a substrate 201 that includes a semiconductor material 202. The substrate 201 may be manifested as a bulk silicon wafer, a bulk silicon wafer with an epitaxial silicon layer, or an SOI wafer. The substrate 201 may have additional microelectronic devices identical to the microelectronic device 200.

A first portion 206a of a first dielectric layer 206 is formed on the semiconductor material 202. The first portion 206a of the first dielectric layer 206 may be formed by a sequence of processes, such as a thermal oxidation process to form a stress relief layer, a low pressure chemical vapor deposition (LPCVD) process using ammonia and dichlorosilane to form a liner of silicon nitride on the relief layer, a PECVD process using TEOS and oxygen to form a main layer of silicon dioxide on the liner, and a PECVD process using bis(tertiary-butyl-amino)silane (BTBAS) and ammonia to form cap layer of silicon nitride on the planarized main layer. Other process sequences to form the first portion 206a of the first dielectric layer 206 are within the scope of this example. Other layer structures and compositions for the first portion 206a of the first dielectric layer 206 are within the scope of this example.

A contact etch mask 220 is formed over the first portion 206a of the first dielectric layer 206, exposing the first portion 206a of the first dielectric layer 206 in an area for a shunt contact 218, shown in FIG. 2B. The contact etch mask 220 may include photoresist, patterned by a photolithographic process.

A contact etch process 221 removes dielectric material from the first portion 206a of the first dielectric layer 206 where exposed by the contact etch mask 220, to form a contact hole 222 which exposes the semiconductor material 202. The contact etch process 221 may be implemented as a reactive ion etch (RIE) process using fluorine radicals and argon ions to anisotropically remove the dielectric material. After the contact hole 222 is formed, the contact etch mask 220 is removed. The contact etch mask 220 may be removed by a plasma process using oxygen radicals, by a wet strip process using n-methyl pyrrolidone (NMP), or a combination of both, by way of example.

Referring to FIG. 2B, a shunt contact 218 is formed in the contact hole 222, making an electrical connection to the semiconductor material 202. The shunt contact 218 may be formed by forming an adhesion layer 223 of titanium by a sputter process on the first portion 206a of the first dielectric layer 206, extending into the contact hole 222 and onto the semiconductor material 202. Formation of the shunt contact 218 may be continued by forming a barrier layer 224 of titanium nitride by an atomic layer deposition (ALD) process on the adhesion layer 223. Formation of the shunt contact 218 may be continued by forming a core 225 of tungsten on the barrier layer 224 by a metal organic chemical vapor deposition (MOCVD) process using tungsten hexafluoride reduced initially by silane and subsequently by hydrogen. The adhesion layer 223, the barrier layer 224, and the core 225 may be removed from a top surface of the first portion 206a of the first dielectric layer 206 outside of the contact hole 222 by a metal chemical mechanical polish (CMP) process, and etchback process, or a combination of both, leaving the adhesion layer 223, the barrier layer 224, and the core 225 in the contact hole 222. The substrate 201 may subsequently be heated to react the titanium in the adhesion layer 223 with silicon in the semiconductor material 202 to form a contact layer 226 of titanium silicide at a bottom of the shunt contact 218. The contact layer 226 may advantageously provide a reduced electrical resistance between the shunt contact 218 and the semiconductor material 202. In alternative versions of this example, the shunt contact 218 may be formed by other processes and materials. For example, the shunt contact 218 may include cobalt, formed by a selective deposition process.

Referring to FIG. 2C, a first interconnect layer stack 227 is formed over the first portion 206a of the first dielectric layer 206 and the shunt contact 218. The first interconnect layer stack 227 may include an adhesion layer 228 of titanium or titanium tungsten, on the first portion 206a of the first dielectric layer 206 and the shunt contact 218, a lower barrier layer 229 of titanium nitride on the adhesion layer 228, an aluminum layer 230 with a few atomic percent of silicon, titanium, or copper, on the lower barrier layer 229, and an upper barrier layer 231 of titanium nitride on the aluminum layer 230. The first interconnect layer stack 227 may be formed by a sequence of sputter processes.

A first interconnect etch mask 232 is formed over the first interconnect layer stack 227, covering the first interconnect layer stack 227 in areas for a shunt interconnect line 217 and an optional lower winding return line 233, both shown in FIG. 2D. The first interconnect etch mask 232 may include photoresist, patterned by a photolithographic process. The first interconnect etch mask 232 may also include anti-reflection material, such as a bottom anti-reflection coat (BARC).

Referring to FIG. 2D, a first interconnect etch process 234 removes material from the first interconnect layer stack 227 where exposed by the first interconnect etch mask 232 to form the shunt interconnect line 217 and the lower winding return line 233. The first interconnect etch process 234 may be implemented as an RIE process using chlorine radicals. After the shunt interconnect line 217 and the lower winding return line 233 are formed, the first interconnect etch process 234 may be removed.

Referring to FIG. 2E, a second portion 206b of the first dielectric layer 206 is formed over the first portion 206a of the first dielectric layer 206, the shunt interconnect line 217, and the lower winding return line 233. The second portion 206b of the first dielectric layer 206 may include a planarized main layer formed by an HDP process and a PECVD process using TEOS, and planarized by an oxide CMP process, and an etch stop layer of silicon nitride or silicon carbonitride formed by a PECVD process using BTBAS. Other process sequences to form the second portion 206b of the first dielectric layer 206 are within the scope of this example. Other layer structures and compositions for the second portion 206b of the first dielectric layer 206 are within the scope of this example.

A conductive field deflector 210 and an optional winding via 235 are formed, extending through the second portion 206b of the first dielectric layer 206 and making electrical connections to the shunt interconnect line 217 and the lower winding return line 233, respectively. The conductive field deflector 210 and the winding via 235 may be formed concurrently by forming a field deflector trench 236 through the second portion 206b of the first dielectric layer 206 for the conductive field deflector 210 and a via hole 237 through the second portion 206b of the first dielectric layer 206 for the winding via 235. The field deflector trench 236 may extend completely around an interior region 208 of the first dielectric layer 206, or may be segmented into a plurality of field deflector trenches 236.

Concurrent formation of the conductive field deflector 210 and the winding via 235 may be continued with formation of an adhesion layer 238 that includes titanium on the second portion 206b of the first dielectric layer 206, extending into the field deflector trench 236 and the via hole 237 and making contact with the shunt interconnect line 217 and the lower winding return line 233. A barrier layer 239 of titanium nitride is formed on the adhesion layer 238 over the second portion 206b of the first dielectric layer 206 and in the field deflector trench 236 and the via hole 237. A core 240 of tungsten is formed on the barrier layer 239 over the second portion 206b of the first dielectric layer 206 and in the field deflector trench 236 and the via hole 237. The adhesion layer 238, the barrier layer 239, and the core 240 are removed from over the second portion 206b of the first dielectric layer 206 outside of the field deflector trench 236 and the via hole 237. The adhesion layer 238, the barrier layer 239, and the core 240 in the field deflector trench 236 and the via hole 237 provide the conductive field deflector 210 and the winding via 235, respectively. The conductive field deflector 210 and the winding via 235 extend to a top surface of the second portion 206b of the first dielectric layer 206. Other processes and materials for forming the conductive field deflector 210 and a winding via 235 are within the scope of this example.

In this example, a combination of the shunt interconnect line 217 and the shunt contact 218 provide a shunt 216. A combination of the shunt 216 and the conductive field deflector 210 provide the field suppression structure 209 of the microelectronic device 200.

Referring to FIG. 2F, a lower winding 204 of the galvanic isolation component 203 is formed on the second portion 206b of the first dielectric layer 206, making an electrical connection to the winding via 235. The lower winding 204 may include an adhesion layer 241 on the second portion 206b of the first dielectric layer 206 and the winding via 235, a lower barrier layer 242 on the adhesion layer 241, an aluminum layer 243 on the lower barrier layer 242, and an upper barrier layer 244 on the aluminum layer 243. Forming the conductive field deflector 210 to extend to the top surface of the second portion 206b of the first dielectric layer 206, and forming the lower winding 204 on the second portion 206b of the first dielectric layer 206, provides that a top surface 213 of the conductive field deflector 210 is substantially coplanar with a bottom surface 214 of the lower winding 204.

A second dielectric layer 207 is formed over the second portion 206b of the first dielectric layer 206, the lower winding 204, the conductive field deflector 210, and a winding via 235. The second dielectric layer 207 may include a plurality of sublayers of dielectric material, and may be formed by a series of PECVD processes. The second dielectric layer 207 may be planarized.

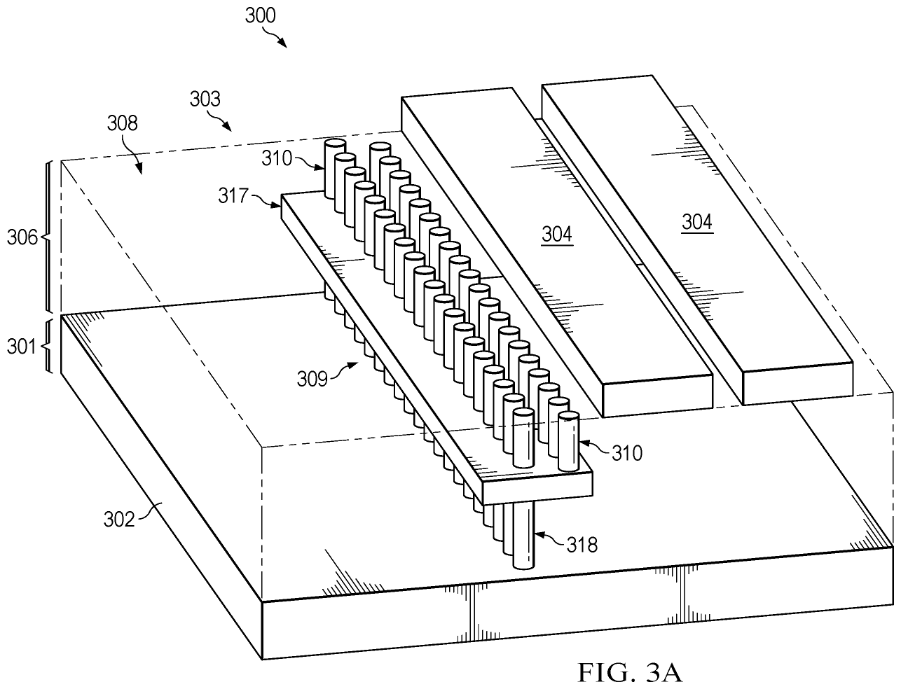

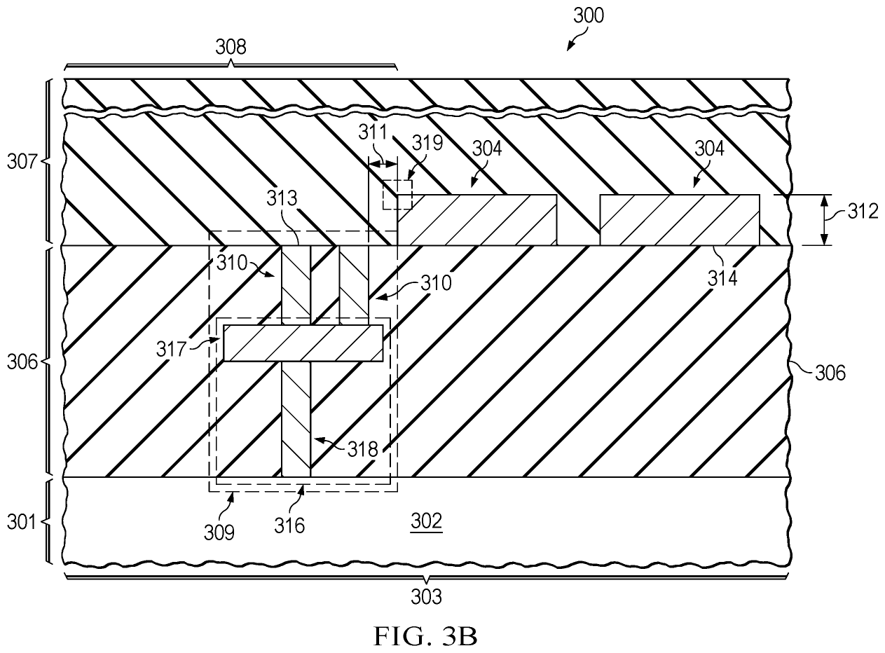

FIG. 3A and FIG. 3B are a perspective and a cross-section, respectively, of another example microelectronic device having a galvanic isolation component with a field suppression structure. The microelectronic device 300 includes a substrate 301 having a semiconductor material 302. The microelectronic device 300, the substrate 301, and the semiconductor material 302 may be manifested as any of the devices, substrates, and semiconductor materials disclosed in reference to the microelectronic device 100, the substrate 101, and the semiconductor material 102 of FIG. 1A and FIG. 1B.

The microelectronic device 300 includes a galvanic isolation component 303 over the substrate 301. The galvanic isolation component 303 includes a lower winding 304 and an upper isolation element, not shown, over the lower winding 304. FIG. 3A shows only a portion of the lower winding 304.

The microelectronic device 300 includes a first dielectric layer 306 separating the lower winding 304 from the substrate 301. The first dielectric layer 306 may include a plurality of sublayers, not specifically shown. The microelectronic device 300 includes a second dielectric layer 307 over the lower winding 304 and the first dielectric layer 306, separating the upper isolation element from the lower winding 304. The second dielectric layer 307 may include a plurality of sublayers, not specifically shown. The second dielectric layer 307 is sufficiently thick to provide reliable operation of the microelectronic device 300 when a potential difference of at least 600 volts is applied between the upper isolation element and the lower winding 304.

The lower winding 304 surrounds an interior region 308 of the first dielectric layer 306 and the second dielectric layer 307. The microelectronic device 300 includes a field suppression structure 309 in the interior region 308. The field suppression structure 309 is located interior to the lower winding 304. The field suppression structure 309 includes a conductive field deflector 310 that is separated from the lower winding 304 by a lateral distance 311 that is half a thickness 312 of the lower winding 304 to twice the thickness 312 of the lower winding 304. A top surface 313 of the conductive field deflector 310 is substantially coplanar with a bottom surface 314 of the lower winding 304. The conductive field deflector 310 is electrically connected to the semiconductor material 302. The conductive field deflector 310 of this example may include an array of separate conductive elements, such as alternating rows of the separate conductive elements, as depicted in FIG. 3A. The conductive field deflector 310 of this example may extend completely around the interior region 308.

In this example, the conductive field deflector 310 may be electrically connected to the semiconductor material 302 through a shunt 316 that extends from the conductive field deflector 310 through the first dielectric layer 306 to the semiconductor material 302. The shunt 316 of this example may include a shunt interconnect line 317 under the conductive field deflector 310 and one or more shunt contacts 318 extending between the shunt interconnect line 317 and the semiconductor material 302. The first dielectric layer 306 and the second dielectric layer 307 are not shown in FIG. 1A, to show the lower winding 304 and the field suppression structure 309 more clearly.

The field suppression structure 309 of this example may advantageously reduce the electric field at an upper interior corner 319 of the lower winding 304 during operation of the microelectronic device 300, as disclosed in reference to the field suppression structure 109 of FIG. 1A and FIG. 1B.

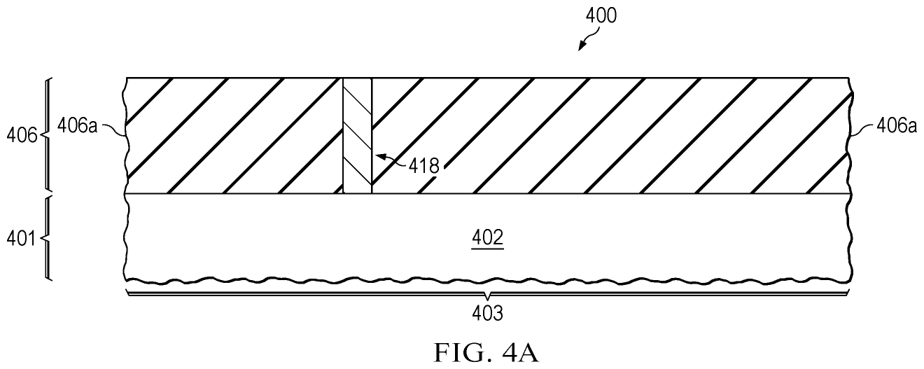

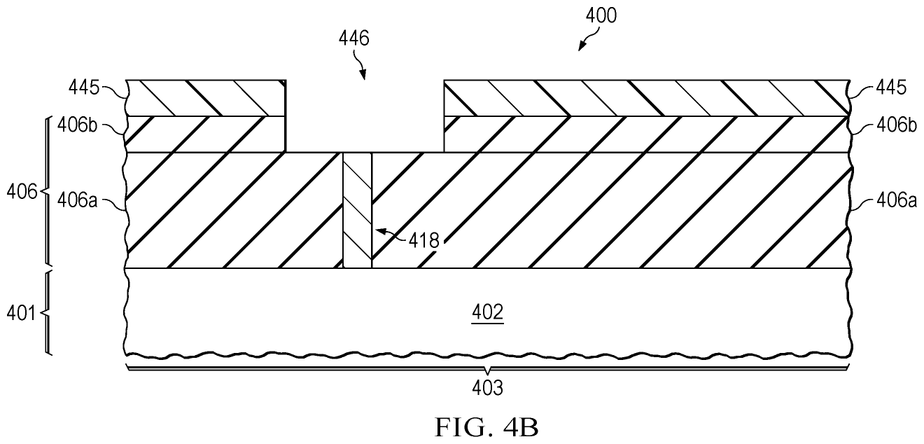

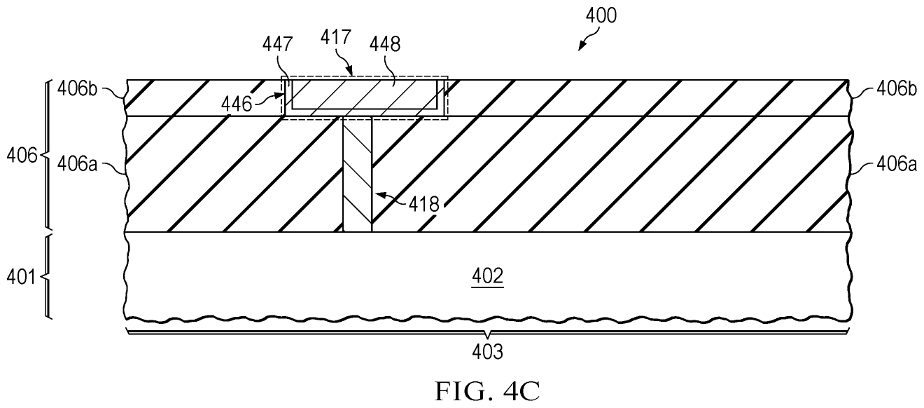

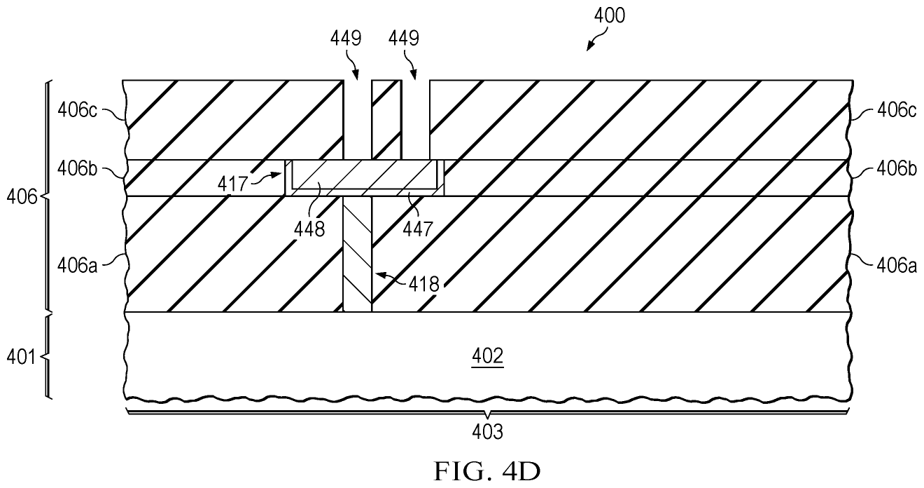

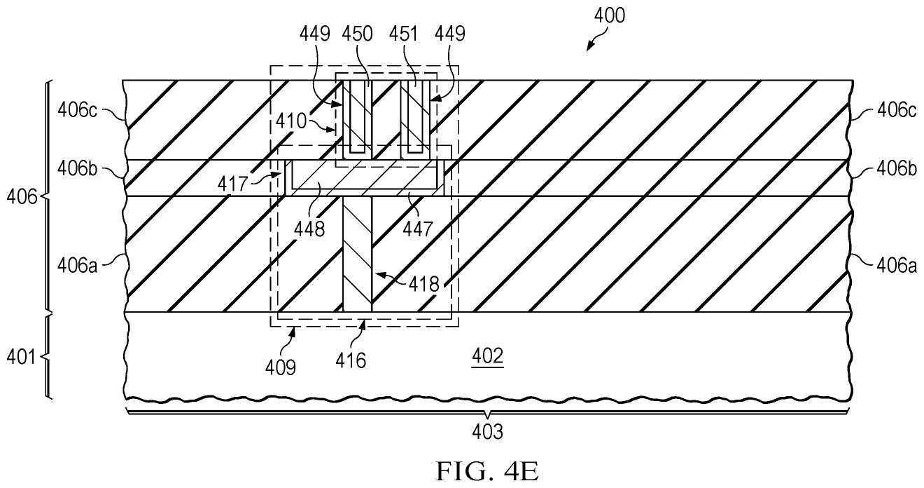

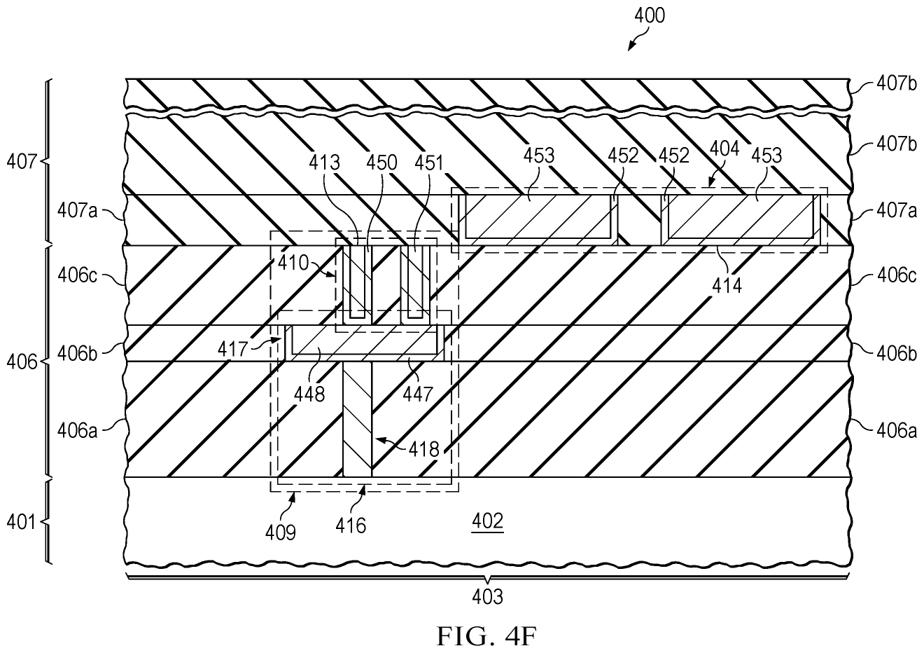

FIG. 4A through FIG. 4F are cross sections of a microelectronic device having a galvanic isolation component with a field suppression structure, depicted in successive stages of an example method of formation. Referring to FIG. 4A, the microelectronic device 400 is formed on a substrate 401 that includes a semiconductor material 402. The substrate 401 may have additional microelectronic devices identical to the microelectronic device 400.

A first portion 406a of a first dielectric layer 406 is formed on the semiconductor material 402. The first portion 406a of the first dielectric layer 406 may be formed as disclosed in reference to the first portion 206a of the first dielectric layer 206 of FIG. 2A. Other process sequences and other layer structures and compositions for the first portion 406a of the first dielectric layer 406 are within the scope of this example.

A shunt contact 418 is formed through the first portion 406a of the first dielectric layer 406, making an electrical connection to the semiconductor material 402. The shunt contact 418 may be formed as disclosed in reference to the shunt contact 218 of FIG. 2B. In alternative versions of this example, the shunt contact 418 may be formed by other processes and materials.

Referring to FIG. 4B, a second portion 406b of the first dielectric layer 406 is formed over the first portion 406a of the first dielectric layer 406. The second portion 406b of the first dielectric layer 406 may include a plurality of sublayers, not specifically shown, such as an etch stop layer of silicon nitride on the first portion 406a of the first dielectric layer 406, a main layer of silicon dioxide on the etch stop layer, and a CMP stop layer on the main layer. The second portion 406b of the first dielectric layer 406 may be formed by a sequence of PECVD processes.

A trench etch mask 445 is formed over the second portion 406b of the first dielectric layer 406 that exposes the second portion 406b of the first dielectric layer 406 above the shunt contact 418. Dielectric material is removed from the second portion 406b of the first dielectric layer 406 where exposed by the trench etch mask 445 to form an interconnect trench 446. The interconnect trench 446 extends to the shunt contact 418. The dielectric material may be removed from the second portion 406b of the first dielectric layer 406 by a series of RIE processes. The trench etch mask 445 is removed after the interconnect trench 446 is formed.

Referring to FIG. 4C, a shunt interconnect line 417 is formed in the interconnect trench 446. The shunt interconnect line 417 may be formed by a damascene process which includes forming a barrier liner 447 of tantalum and tantalum nitride on the second portion 406b of the first dielectric layer 406, extending into the interconnect trench 446 and making an electrical connection to the shunt contact 418. The barrier liner 447 may be formed by a sputter process followed by an ALD process, by way of example. A fill metal 448 of copper is formed on the barrier liner 447 by sputtering a seed layer, not specifically shown, of copper on the barrier liner 447 and electroplating copper on the seed layer. The barrier liner 447 and the fill metal 448 over the second portion 406b of the first dielectric layer 406, outside of the interconnect trench 446, is removed by a copper CMP process, leaving the barrier liner 447 and the fill metal 448 in the interconnect trench 446 to form the shunt interconnect line 417.

Referring to FIG. 4D, a third portion 406c of the first dielectric layer 406 is formed over the shunt interconnect line 417 and the second portion 406b of the first dielectric layer 406. The third portion 406c of the first dielectric layer 406 may include a plurality of sublayers, not specifically shown, such as an etch stop layer of silicon nitride on the second portion 406b of the first dielectric layer 406, a main layer of silicon dioxide on the etch stop layer, and a CMP stop layer of silicon nitride or silicon carbonitride on the main layer, similar to the plurality of sublayers disclosed in reference to the second portion 406b of the first dielectric layer 406 of FIG. 4C. The third portion 406c of the first dielectric layer 406 may be formed by a sequence of PECVD processes, similar to those used to form the second portion 406b of the first dielectric layer 406.

An array of field deflector openings 449 are formed through the third portion 406c of the first dielectric layer 406, exposing the shunt interconnect line 417. The field deflector openings 449 may be formed by a patterning a deflector opening etch mask, not specifically shown, over the third portion 406c of the first dielectric layer 406, and removing dielectric material from the third portion 406c of the first dielectric layer 406 where exposed by the deflector opening etch mask using a series of RIE processes, similar to formation of the interconnect trench 446. The deflector opening etch mask is subsequently removed. The array of field deflector openings 449 may be arranged in two or more alternating rows, by way of example.

Referring to FIG. 4E, a conductive field deflector 410 is formed in the field deflector openings 449. The conductive field deflector 410 may be formed by another damascene process, which includes forming a barrier liner 450 of tantalum and tantalum nitride on the third portion 406c of the first dielectric layer 406, extending into the field deflector openings 449 and making an electrical connection to the shunt interconnect line 417. Formation of the conductive field deflector 410 continues with forming a fill metal 451 of copper on the barrier liner 450, followed by a copper CMP process. Forming the conductive field deflector 410 as an array of separate members may provide increased process latitude compared to forming the conductive field deflector 410 as a continuous structure.

In this example, a combination of the shunt interconnect line 417 and the shunt contact 418 provide a shunt 416. A combination of the shunt 416 and the conductive field deflector 410 provide the field suppression structure 409 of the microelectronic device 400.

Referring to FIG. 4F, a first portion 407a of a second dielectric layer 407 is formed over the first dielectric layer 406 and the conductive field deflector 410. The first portion 407a of the second dielectric layer 407 may include a plurality of sublayers, not specifically shown, such as an etch stop layer of silicon nitride on the first dielectric layer 406, a main layer of silicon dioxide on the etch stop layer, and a CMP stop layer of silicon nitride or silicon carbonitride on the main layer; formed by a sequence of PECVD processes. The first portion 407a of the second dielectric layer 407 may have a sublayer structure and composition similar to the second portion 406b of the first dielectric layer 406, and may be formed by a similar process sequence.

A lower winding 404 of the galvanic isolation device 403 is formed in the first portion 407a of the second dielectric layer 407, extending to the first dielectric layer 406, so that a top surface 413 of the conductive field deflector 410 is substantially coplanar with a bottom surface 414 of the lower winding 404. The lower winding 404 of this example may have damascene interconnect lines with a barrier liner 452 of tantalum and tantalum nitride and a fill metal 453 of copper, similar to the shunt interconnect line 417. The lower winding 404 of this example may be formed by a damascene process similar to the damascene process used to form the shunt interconnect line 417. The lower winding 404 of this example may be thicker than the shunt interconnect line 417. Having the etch stop layer in the first portion 407a of the second dielectric layer 407 may facilitate forming the lower winding 404 to have the bottom surface 414 substantially coplanar with the top surface 413 of the conductive field deflector 410, by enabling a trench etch process to stop at a controlled height above the first dielectric layer 406, and further enabling a selective etch to remove the remaining etch stop layer.

A second portion 407b of the second dielectric layer 407 is formed over the first portion 407a of the second dielectric layer 407. The second dielectric layer 407 may include a plurality of sublayers of dielectric material, and may be formed by a series of PECVD processes.

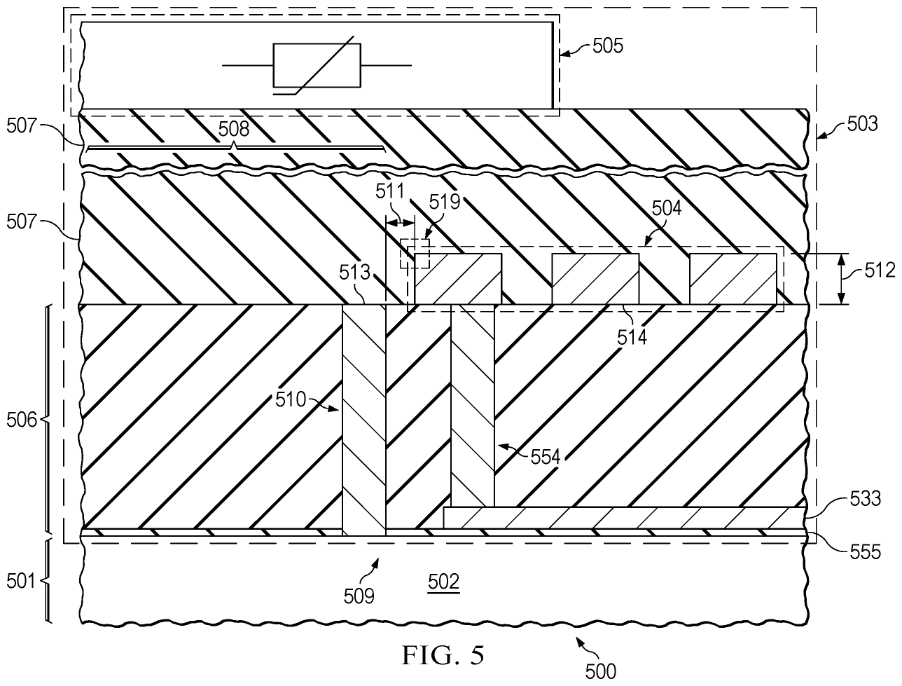

FIG. 5 is a cross section of a further example microelectronic device having a galvanic isolation component with a field suppression structure. The microelectronic device 500 includes a substrate 501 having a semiconductor material 502. The microelectronic device 500, the substrate 501, and the semiconductor material 502 may be manifested as any of the devices, substrates, and semiconductor materials disclosed in reference to the microelectronic device 100, the substrate 101, and the semiconductor material 102 of FIG. 1A and FIG. 1B.

The microelectronic device 500 includes a galvanic isolation component 503 over the substrate 501. The galvanic isolation component 503 includes a lower winding 504 and an upper isolation element 505 over the lower winding 504. FIG. 5 shows only a portion of the lower winding 504 and the upper isolation element 505. This example, the upper isolation element 505 may be manifested as a magnetic sensor, as indicated schematically in FIG. 5.

The microelectronic device 500 includes a first dielectric layer 506 separating the lower winding 504 from the substrate 501. The lower winding 504 surrounds an interior region 508 of the first dielectric layer 506. The field suppression structure 509 of this example includes a conductive field deflector 510 in the interior region 508 which extends through the first dielectric layer 506 to the semiconductor material 502 and makes a direct electrical connection to the semiconductor material 502. A top surface 513 of the conductive field deflector 510 is substantially coplanar with a bottom surface 514 of the lower winding 504. The conductive field deflector 510 is separated from the lower winding 504 by a lateral distance 511 that is half a thickness 512 of the lower winding 504 to twice the thickness 512 of the lower winding 504. During operation of the microelectronic device 500, the conductive field deflector 510 may advantageously reduce an electric field at an upper interior corner 519 of the lower winding 504.

In this example, the galvanic isolation component 503 may include a lower winding return line 533 above the substrate 501, extending to an interior terminal of the lower winding 504. The lower winding return line 533 may be connected to the interior terminal of the lower winding 504 through a winding contact 554 in the first dielectric layer 506. The winding contact 554 may be formed concurrently with the conductive field deflector 510. The lower winding return line 533 may include metal, such as aluminum, or may include metal silicide, such as cobalt silicide. The lower winding return line 533 may be separated from the semiconductor material 502 by a layer of thermal oxide 555. The microelectronic device 500 includes a second dielectric layer 507 separating the lower winding 504 from the upper isolation element 505.

Various features of the examples disclosed herein may be combined in other manifestations of example microelectronic devices. For example, any of the conductive field deflectors 110, 310, or 510 may be continuous or may include an array of separate conductive elements. Any of the field suppression structures 109, 309, or 509 may include conductors of primarily aluminum or damascene copper.

While various embodiments of the present disclosure have been described above, it should be understood that they have been presented by way of example only and not limitation. Numerous changes to the disclosed embodiments can be made in accordance with the disclosure herein without departing from the spirit or scope of the disclosure. Thus, the breadth and scope of the present invention should not be limited by any of the above described embodiments. Rather, the scope of the disclosure should be defined in accordance with the following claims and their equivalents.

What is claimed is:

1. A microelectronic device, comprising:
a substrate including a semiconductor material; and
an isolation component over the substrate, the isolation component including:
a lower winding, separated from the substrate by a first dielectric layer of the microelectronic device;
an upper winding over the lower winding, the upper winding being separated from the lower winding by a second dielectric layer of the microelectronic device; and
a field suppression structure located interior to the lower winding, wherein the lower winding extends around the field suppression structure, the field suppression structure including a conductive field deflector separated from the lower winding by a lateral distance less that is half a thickness of the lower winding to twice the thickness of the lower winding, wherein the conductive field deflector is electrically connected to the semiconductor material.

2. The microelectronic device of claim 1, wherein a width of a top surface of the conductive field deflector is greater than half of the thickness of the lower winding.

3. The microelectronic device of claim 1, wherein a top surface of the conductive field deflector is substantially coplanar with a bottom surface of the lower winding.

4. The microelectronic device of claim 1, wherein the conductive field deflector includes separate segments around a region interior to the lower winding.

5. The microelectronic device of claim 1, wherein the field suppression structure is manifested as a continuous via over a shunt interconnect line, the shunt interconnect line being connected to the semiconductor material.

6. The microelectronic device of claim 1, wherein the field suppression structure includes a shunt, and the conductive field deflector is electrically connected to the semiconductor material through the shunt.

7. The microelectronic device of claim 5, wherein the shunt includes a contact on the semiconductor material.

8. The microelectronic device of claim 1, wherein the conductive field deflector includes array of separate conductive elements.

9. The microelectronic device of claim 1, wherein the conductive field deflector makes a direct electrical connection to the semiconductor material.

10. The microelectronic device of claim 1, wherein the lower winding includes primarily aluminum.

11. A method of forming a microelectronic device, comprising:
forming a conductive field deflector over a substrate of the microelectronic device, the conductive field deflector being electrically conductive and connected to a semiconductor material of the substrate; and
forming a lower winding over the substrate around the conductive field deflector, the lower winding being electrically conductive, wherein the conductive field deflector is separated from the lower winding by a lateral distance that is half a thickness of the lower winding to twice the thickness of the lower winding, a top surface of the conductive field deflector being substantially coplanar with a bottom of the lower winding.

12. The method of claim 11, wherein a width of a top surface of the conductive field deflector is greater than half of the thickness of the lower winding.

13. The method of claim 11, further including:
forming a first dielectric layer on the semiconductor material;
forming a shunt contact through the first dielectric layer to the semiconductor material, the shunt contact making an electrical connection to the semiconductor material;
forming a shunt interconnect line on the shunt contact;
forming a second dielectric layer over the shunt interconnect line and the first dielectric layer;
forming the conductive field deflector through the second dielectric layer, the conductive field deflector making an electrical connection to the shunt interconnect line; and
forming the lower winding over the second dielectric layer.

14. The method of claim 11, further including forming an electrically conductive shunt connecting the conductive field deflector to the semiconductor material.

15. The method of claim 11, wherein forming the conductive field deflector includes forming trenches in a dielectric layer, the trenches extending around a region interior to the lower winding, and forming conductive material in the trench.

16. The method of claim 11, wherein forming the conductive field deflector includes:
forming a trench in a dielectric layer;
forming a barrier liner in the trench, contacting the dielectric layer; and
forming a core in the trench on the barrier liner.

17. The method of claim 11, wherein forming the lower winding includes:
forming an interconnect layer stack on a dielectric layer including the conductive field deflector, the interconnect layer stack including an interconnect layer including primarily aluminum;
forming an etch mask over the interconnect layer stack;
removing the interconnect layer stack where exposed by the etch mask, and removing the etch mask.

18. The method of claim 11, wherein forming the conductive field deflector includes forming a plurality of separate openings in a dielectric layer, and forming conductive material in the separate openings.

19. The method of claim 11, wherein the conductive field deflector is formed directly on the semiconductor material.

20. A microelectronic device, comprising:
a substrate including a semiconductor material; and
an isolation component over the substrate, the isolation component including:
a lower winding, separated from the substrate by a first dielectric layer of the microelectronic device;
an upper winding over the lower winding, the upper winding being separated from the lower winding by a second dielectric layer of the microelectronic device; and
a field suppression structure located interior to the lower winding, wherein the lower winding extends around the field suppression structure, the field suppression structure including a conductive field deflector separated from the lower winding, wherein the conductive field deflector is electrically connected to the semiconductor material.
